(19) United States
(12) Patent Application Publication
(10) Pub. No.: US 2013/0227883 A1
(43) Pub. Date: Sep. 5, 2013

(54) METHOD, APPARATUS AND SYSTEM FOR INCREASING LIGHT TO PLANTS

(71) Applicant: Pacilio D. Vassallo, Warminster, PA (US)

(72) Inventor: Pacilio D. Vassallo, Warminster, PA (US)

(21) Appl. No.: 13/781,230

(22) Filed: Feb. 28, 2013

Related U.S. Application Data
(60) Provisional application No. 61/605,425, filed on Mar. 1, 2012.

(51) Int. Cl. A01G 9/02

(52) U.S. Cl. CPC A01G 9/02
USPC 47/66.6; 47/66.7

(57) ABSTRACT

A system, apparatus and method for providing increased light to plants including a bottom panel including tiles, side panels coupled substantially perpendicular to the bottom panel at a first edge of the bottom panel and providing a first reflector to redirect light, end panels coupled substantially perpendicular to the bottom panel at a second edge of the bottom panel and substantially orthogonal to some of the side panels and providing a second reflector to redirect light, a container configured to house the plants being supported by the bottom panel and providing a third reflector to redirect light, and light sources producing light beneficial to the plants, the light incident upon the bottom panel, the side panels, the end panels, and the container, the bottom panel, side panels, ends panels, and container each reflecting a portion of the incident light is disclosed.

### CROSS REFERENCE TO RELATED APPLICATIONS

This application claims the benefit of U.S. Patent Application No. 61/605,425, which is entitled SUNBURST SYSTEM, filed Mar. 1, 2012 with inventor Pacilio D. Vassallo, and is incorporated herein by reference as if fully set forth.

### FIELD

The disclosure relates to a method, apparatus and system for growing plants, and more specifically, a method, apparatus and system for increasing light to plants.

### BACKGROUND

Plants need light to grow. Plants have cell walls with cellulose and characteristically obtain most of their energy from sunlight via photosynthesis using chlorophyll contained in chloroplasts. Plants are photosynthetic, which means that they manufacture their own food molecules using energy obtained from light. The primary mechanism plants have for capturing light energy is the pigmented chlorophyll. Photosynthesis is a process where plants use the energy and sunlight to convert carbon dioxide from the atmosphere, plus water, into simple sugars. The sugars are then used as building blocks and form the main structural component of the plant. Chlorophyll is essential to this process. Plants also rely on the soil for support and water, but also obtain compounds of nitrogen, phosphorus, potassium, magnesium and other elemental nutrients. Growth of plants is determined by many environmental factors, such as temperature, available water, available light, and available nutrients in the soil. Plants compete with other plants for space, water, light and nutrients. Plants also require proper temperature. Plants of all types, including crop plants and flowers, are commonly grown indoors. Indoor plants may need an artificial light source.

### SUMMARY

A system, apparatus and method for providing increased light to at least one plant is disclosed. The system includes at least one bottom panel including at least one tile. The system includes one or more side panels operatively coupled to the at least one bottom panel and providing a first reflector to redirect light within the system. The system includes at least one container configured to house the at least one plant, be supported by the at least one bottom panel and providing a second reflector to redirect light within the system.

The apparatus includes at least one container configured to house at least one of a plurality of plants and a reflector to reflect light incident on the container.

The method includes increasing the reflection of the incident light on at least one of at least one bottom panel, one or more side panels, one or more end panels, and at least one container; the at least one bottom panel, the one or more side panels, and the one or more end panels forming a housing for the at least one container, the container configured to house the at least one of a plurality of plants.

### BRIEF DESCRIPTION OF THE DRAWINGS

Understanding of the present invention will be facilitated by consideration of the following detailed description taken in conjunction with the accompanying non-limiting drawings, in which like numerals refer to like parts:

FIG. 1 illustrates a system for providing increased light in a growing environment;

FIG. 2 illustrates a design of a panel support supporting a side or end panel;

FIG. 3 illustrates a panel support having multiple different angled grooves;

FIG. 4 illustrates a configuration of the system of FIG. 1;

FIG. 5 illustrates a depiction of side panel;

FIG. 6 illustrates a depiction of the stand deployed in a system that may hold side panel in the proper position;

FIG. 7 illustrates a depiction of a side view of a tile;

FIG. 8 illustrates a top view of a bottom panel;

FIG. 9 illustrates a depiction of a container that may be utilized in any of the systems described herein;

FIG. 10 illustrates an internal cross-section of container of FIG. 9 cut along line 10-10;

FIG. 11 illustrates a depiction of a container that may be utilized in any of the systems described herein;

FIG. 12 illustrates an internal cross-section of container of FIG. 11 cut along line 12-12;

FIG. 13 illustrates a depiction of a container that may be utilized in any of the system described herein;

FIG. 14 illustrates an internal cross-section of container of FIG. 13 cut along line 14-14;

FIG. 15 illustrates an internal cross-section of a container;

FIG. 16 illustrates a depiction of a cover which may cover a container described herein;

FIG. 17 illustrates a depiction of cover of FIG. 16 partially opened;

FIG. 18 illustrates a container including cover; and

FIG. 19 illustrates a method for providing additional light to a plurality of plants.

### DETAILED DESCRIPTION

It is to be understood that in some aspects the figures and descriptions of the present invention have been simplified to illustrate elements that are relevant for a clear understanding of embodiments of the present invention, while eliminating, for the purpose of clarity, many other elements found in greenhouses and other planting environments. Those of ordinary skill in the art may recognize that other elements and/or steps are desirable and/or required in implementing the embodiments. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

In order to deliver additional light to plants or other organics, a bigger light source may be used. A bigger light source generally requires additional energy to operate. By coupling more of the light from a given light source to the plant or other organic, the benefits of additional light may be realized without the need for a bigger light source or increased energy use.

A system, apparatus and method for providing increased light to at least one of a plurality of plants is disclosed. The system includes at least one bottom panel including at least one tile, one or more side panels operably coupled to the at least one bottom panel to provide a first reflector to redirect light within the system. A bottom panel may be operably coupled at a first edge of the bottom panel. The one or more side panels may be substantially perpendicular to the at least one bottom panel. The system may include one or more end panels operably coupled to the at least one bottom panel. The one or more end panels may by substantially perpendicular to the at least one bottom panel. An end panels may be at a second edge of the bottom panel and substantially orthogonal to some of the one or more side panels and providing a second reflector to redirect light within the system. The system may include at least one container configured to house at least one plant and be supported by the at least one bottom panel. The at least one container may include a third reflector to redirect light within the system. The system may include one or more light sources producing light beneficial to at least one of the plants. The light incident upon the bottom panel, the one or more side panel(s), the one or more end panel(s), or the at least one container may reflect a portion of the incident light toward a plant(s) within the system when operably coupled.

The at least one tile increases reflection of the bottom panel. The at least one or more side panels and end panels include a pattern and/or reflector to increase the reflectivity of the panels to provide additional light incident on a plant housed in the container.

The system and apparatus may also include at least one cover for the at least one container, the cover including a first portion and a second portion that may be coupled via an attachment. The cover may include an opening to allow the plant to grow through. The cover may also include at least one of a curvature or slope to allow water incident on the cover to flow into the container via the opening.

The at least one cover and/or at least one container may include a pattern and/or reflector to increase the reflectivity of the cover to provide additional light incident on the plant housed in the container.

The method includes providing light from at least one light source to at least one plant, and increasing the reflection of the incident light on at least one of at least one bottom panel, one or more side panels, one or more end panels, and at least one container. The at least one bottom panel, one or more side panels, one or more end panels may form a housing for the at least one container. The at least one container may be configured to house a plant(s).

The method may include increasing the reflection of the incident light on at least one cover for the at least one container. In the method, increasing the reflection may include including a pattern on a surface of the cover to increase the reflectivity of the surface and/or a reflector.

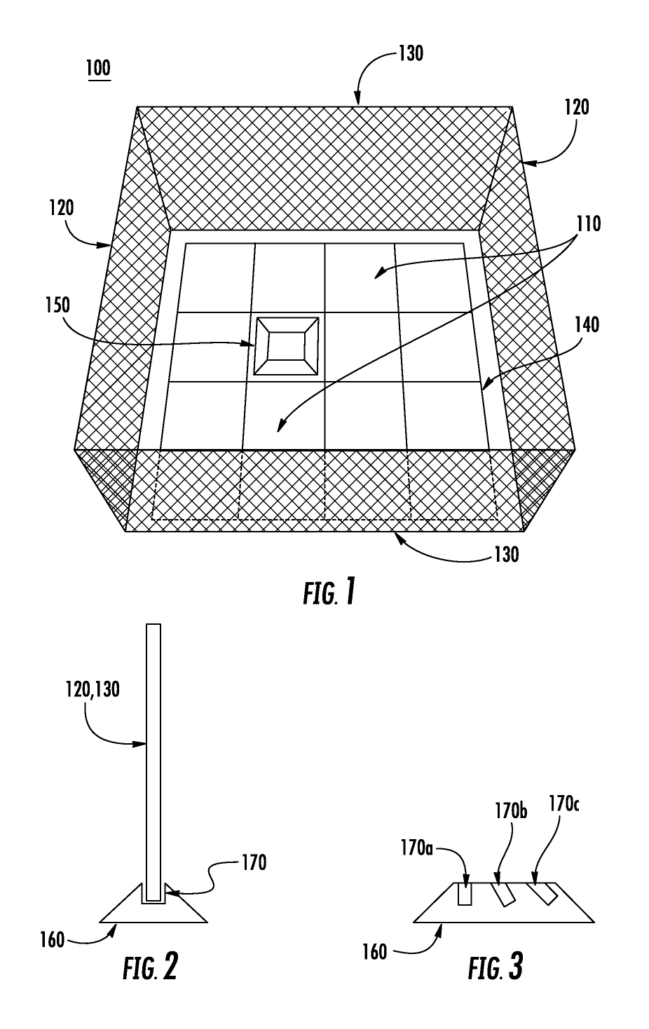

FIG. 1 illustrates a system 100 for providing increased light in a growing environment. System 100 includes a plurality of tiles 110, a plurality of side panels 120, a plurality of end panels 130, a bottom panel 140, which itself may be composed of a plurality of bottom panels 140, and a plurality of containers 150. System 100 is depicted as a square or rectilinear design, although any of a number of configurations may be designed. Some of these designs will be described herein, although the system includes each and every configuration as will be understood by those possessing an ordinary skill in the pertinent arts.

Bottom panel 140 may provide a bed on which any number of containers 150 may rest. Adjacent to the bottom panel 140 and, as shown, perpendicular thereto, are two side panels 120, and orthogonal thereto are two end panels 130. The bottom, side, end panels 140, 120, 130 form a five-sided enclosure, five sides of a cube, for example.

The geometry of side panels 120, end panels 130 and bottom panels 140 may form a cube within which the container 150 is placed. The angles of the side panels 120, end panels 130, to the bottom panel 140 may be varied to produce increased light incident on the plant housed therein. The spacing of the side panels 120, end panels 130, to the bottom panel 140 may be varied to produce increased light incident on the plant housed therein. For example, the side panels 120 and end panels 130 may be placed substantially parallel to the normal of the bottom panel 140, at a 30° to the normal of the bottom panel 140, at a 45° to the normal of the bottom panel 140, or any other suitable angle that operates to increase the light incident upon the plant.

Side panels 120 and end panels 130 may be designed so that the end panels 130 are supported by the side panels 120 and the side panels 120 are supported by the end panels 130. That is, the sides and base of the system may be interconnected, or otherwise support the other sides and base to create a standing unit. Side panels 120 and end panels 130 may be supported by panel supports that connect or hold the panel and maintain the panel in a desired location as described further herein below. Such a support system may include connectors to connect one side panel (or end panel) to a side panel 120, to an end panel 130, to an external support structure, such as a wall, for example, and/or a foot-type support, by way of non-limiting examples only.

Tile 110 may be any shape and/or surface that provides additional light reflection, such as in a direction of an organic that benefits from such additional light reflection. Tile 110 may be of any size and shape. Tile 110 may be water resistant, such as a foam board or plastic, for example. Tile 110 may be placed underneath container 150, adjacent to container 150, or in a position to provide additional light reflection to an organic within container 150.

Tile 110 may include mirrors, including flat, convex, or concave mirrors, for example, holograms, or any other reflector that is improvised or specialized to redirect light toward container(s) 150. Tile 110 may include a pattern to direct or scatter light to container(s) 150.

Side panel 120 may include any number of tiles 110, and/or may include a pattern thereon that provides enhanced light reflection characteristics, as will be described herein below.

End panel 130 may include any number of tiles 110, and/or may include a pattern thereon that provides enhanced light reflection characteristics, as will be described herein below.

Bottom panel 140 may include any number of tiles 110, and/or may include a pattern thereon that provides enhanced light reflection characteristics, as will be described herein below. A tile may be integral with a bottom panel.

Container 150 may contain an organic, such as a plant, that benefits from being provided additional light. Container 150 may be any size and shape and may include therein flowers or other plants that are cultivated and displayed. Container 150 may be made from, but is not limited to, terracotta, plastic, wood, stones, and/or a biodegradable material, including, but not limited to, “Jiffy” pots. Container 150 may include holes in the bottom, to allow excess water to flow out, sometimes to a saucer that may be placed under the flowerpot. The plant can use this water with its roots, as needed. Container 150 may include an automatic watering system, such as by using a reservoir. Container 150 may enable the transporting of plants to new locations, starting seeds, patio and indoor cultivation of plants, and the growing of tender plants in colder regions indoors. Container 150 may include a rim and underneath the rim may be a shoulder or collar to aid in handling.

By way of example, the system 100 may provide increased light to at least one plant by including at least one bottom panel 140 including a plurality of tiles 110. The system 100 may include one or more side panels 120 coupled substantially perpendicular to the at least one bottom panel 140 at a first edge of the bottom panel and providing a first reflector to redirect light within the system. The system 100 may include one or more end panels 130 coupled substantially perpendicular to the at least one bottom panel 140 at a second edge of the bottom panel and substantially orthogonal to at least one of the one or more side panels 120 and providing a second reflector to redirect light within the system. The system 100 may include at least one container 150 configured to house the at least one plant being supported by the at least one bottom panel 140 and providing a third reflector to redirect light within the system. The system 100 may include at least one light source producing light beneficial to the at least one plant in the system, the light incident upon the bottom panel 140, the one or more side panels 120, the one or more end panels 130, and the at least one container 150, the bottom panel 140, one or more side panels 120, one or more ends panels 130, and the at least one container 150 each reflecting a portion of the incident light.

In another example, the system 100 includes at least one bottom panel 140 including at least one tile 110, one or more side panels 120 operatively coupled to the at least one bottom panel 140 and providing a first reflector to redirect light within the system, and at least one container 150 configured to house the at least one plant being supported by the at least one bottom panel 140 and providing a second reflector to redirect light within the system. The system 100 may include one or more end panels 130 operatively coupled to the at least one bottom panel 140 and providing a third reflector to redirect light within the system. The system 100 may include at least one light source producing light beneficial to at least one plant, the light incident upon the bottom panel 140, the one or more side panels 120, and the at least one container 150, the bottom panel 140, one or more side panels 120, and the at least one container 150 each reflecting a portion of the incident light.

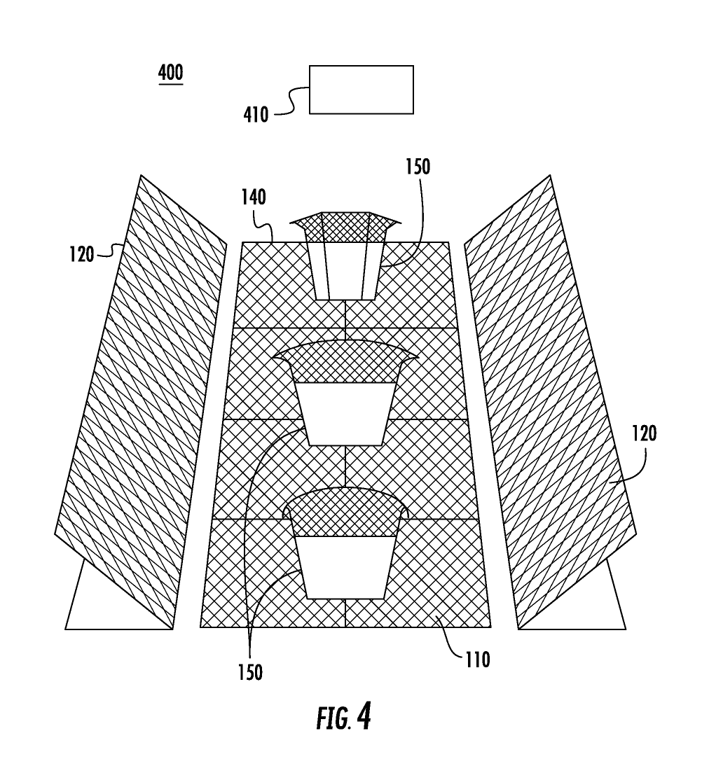

FIG. 2 illustrates a design of a panel support 160 supporting a side or end panel 120, 130. Panel support 160 may include a groove 170, such as a vertical groove 170, for example. Panel 120, 130 may slidably enter panel support 160 and rest in groove 170 to maintain a vertical structure, for example. One or more panel supports 160 may be utilized to support a panel as necessary.

Panel support 160 is illustrated as a dome device with a groove 170 for insertion of the panel to hold. Panel support 160 may take the form of a stabilizing foot, leg assembly or other mechanical supporting mechanism that holds a wall or wall structure. Supporting structures that may be implemented as support 160 may be known to those who possess skill in the modular furniture arts. The panel support 160 shown in FIG. 2 may provide a flat base. Panel support 160 may be made of a material that is able to support the weight of the panel to be held in the conditions that the panel will be placed. The groove 170 within panel support 160 may be designed to maintain the center of gravity of the panel being held over the base of the panel support 160 to thereby prevent tipping of the panel and panel support 160. Groove 170 may be designed to be a depth to prevent swaying of the panel being held and sufficient to prevent tipping of the panel. Groove 170 may geometrically match the panel to be held in width so as to provide a snug fitting to the panel. Groove 170 may be lined with rubber or other gripping material so as to further aid in holding the panel. Groove 170 may also have mechanical devices that pressure the panel to one side of the groove 170 in panel support 160 in the fashion of a Christmas tree stand, for example.

FIG. 3 illustrates a panel support 160 having multiple different angled grooves 170. For example, panel support 160 may include a vertical groove 170a, a 30° groove 170b, and a 45° groove 170c. For each of the grooves 170a-c, a panel 120, 130 may slidably enter panel support 160 and rest in one of the grooves 170 a-c to maintain a vertical, 30°, or 45° structure, for example. Angled grooves at any desired angle may be provided in a panel support 160.

Groove 170a may provide the ability to hold a panel in a vertical manner. Groove 170b may provide the ability to hold a panel at a substantially 30° angle from vertical. Groove 170c may provide the ability to hold a panel at a substantially 45° angle from vertical. Other grooves and angles may be included in panel support 160 as would be understood by those possessing an ordinary skill in the art to achieve the holding of panels and angles desired to provide light to the contents of a container 150.

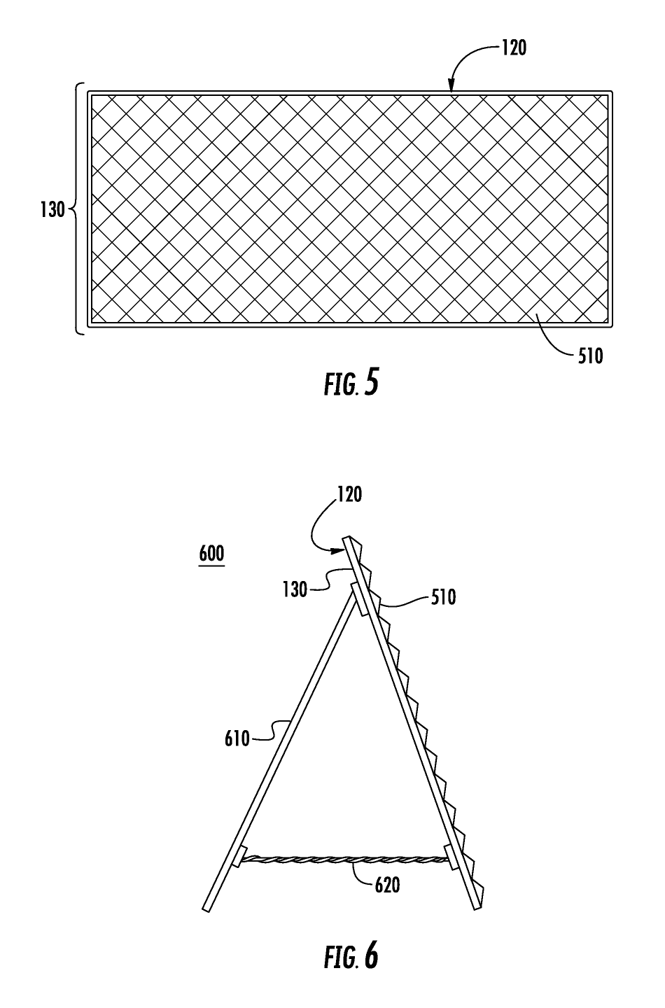

FIG. 4 illustrates a configuration of system 400 that includes additional or alternate supports for the panels. System 400 provides reflection using stands. System 400 includes a plurality of tiles 110, at least one side panel 120 (depicted with two side panels 120), at least one bottom panel 140 (depicted as a 2×4 grid of bottom panels 140), at least one container 150 (depicted as three containers 150), and a light source 410. System 400, and its components, may be positioned in a manner to maximize light disbursement from light source 410 and increase the amount of light that reaches container(s) 150.

System 400 may include any one or more of side panel 120, tile 110, container 150, and light source 410. System 400 may be positioned in a manner that maximizes light dispersement and increases amounts of light absorbed by a plant positioned in system 400. System 400 may contain one or more tiles 110. System 400 may contain one or more containers 150. Tile 110 may be positioned underneath one or more containers 150. System 400 may contain one or more side panels 120. Side panels 120 may be positioned on any side of container 150 in order to achieve a desired reflectivity to reflect incident light toward the plant. Light source 410 may be positioned in any location relative to system 400. Light source 410 may be positioned above system 400. Light source 410 may be positioned directly above tile 110. Light source 410 may be the sun, for example, or any other light source, including natural and artificial lights and lamps, that produces light beneficial to plants.

FIG. 5 illustrates a depiction of side panel 120. Side panel 120 may be attached to end panel 130. Side panel 120 may include a pattern 510. Pattern 510 may be of any suitable shape. For example, pattern 510 may be a diamond shaped pattern. Pattern 510 may be raised, flat, indented or any combination thereof. Pattern 510 may be made of or coated with a reflective material. Pattern 510 may be made of or coated with mylar or a mylar-like material.

Pattern 510 may be a raised pattern. Side panel 120 may be any suitable material. Side panel 120 may be any water resistant material. Side panel 120 may be foam board. Side panel 120 may be plastic.

Pattern 510 may be of any suitable shape pattern. Pattern 510 may be a diamond-shaped pattern. Pattern 510 may be raised, flat, indented, or any combination thereof. Pattern 510 may be made of or coated with any reflective material. Pattern 510 may be made or coated with mylar or mylar-like reflective material. Pattern 510 may be made of or coated with any material that reflects light. Pattern 510 may be a raised pattern. Pattern 510 may be a raised pattern that scatters light.

Pattern 510 may take the form of a pattern cut into the panel that produces manipulates the light to certain areas upon reflection. Such a pattern may include a grating, for example. Other patterns 510 may include protrusions, such as saw-tooth protrusions that redirect the light upon reflection to certain locations. The areas and location would be the location of containers housing plants, for example. Pattern 510 may include increased reflectivity, such as by coating the surface or making the surface from materials that are known to have increased reflectivity. Pattern 510 may be an additional layer that is added, mechanically or otherwise, to the surface of a panel, or may be placed directly into, or on that surface.

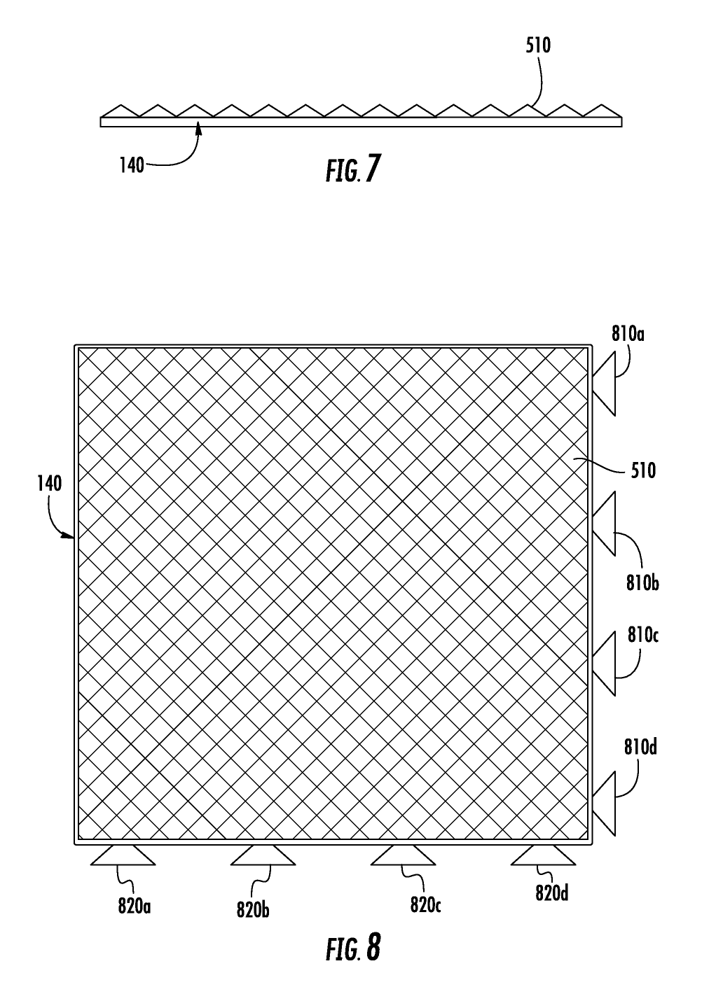

FIG. 6 illustrates a depiction of the stand 600 deployed in system 400 that may hold side panel 120 in the proper position. Stand 600 may include a stand support 610 and a tether 620. The stand support 610 may support the side panel 120 or end panel 130, or both. Panel 120, 130 may include a pattern 510 as described herein. Tether 620 may be adjustable. Tether 620 may be made of any suitable material, such as a chain, an elastic band, or a bungee cord. The tether 620 may connect stand support 610 to side panel 120 to allow the side panel 120 to be positioned to provide light towards container(s) 150. Tether 620 may include one or more adjusters for lengthening or shortening tether 620. Tether 620 may be sized to allow side panel 120 to move from approximately 90° angle relative to container 150 and much higher angle as the contents of the container 150 grow larger. This larger angle may include up to 180°.

End panel 130 may be free standing. Tether 620 may be of any suitable material. Tether 620 may be, but is not limited to a chain, an elastic band or a bungee cord. Tether 620 connects the end panel 130 and stand support 610 in a manner that allows the end panel 130 to be positioned for desired reflectivity toward a plant. Tether 620 may include adjuster(s) for lengthening or shortening the tether. Tether 620 may be formed in a manner that allows end panel 130 to move from a 90° angle relative to the plant, to a 180° angle relative to the plant as plant gets larger.

Stand support 610 may be any suitable material. Stand support 610 may be a water resistant material. Stand support 610 may be foam board. Stand support 610 may be plastic. Stand support 610 may provide the strength to maintain side panel 120, or end panel 130, in a given configuration, including but not limited to vertical, 30°, or 45°, for example.

Stand 600 may be used to hold up any of the panels described herein, including, but not limited to, side panels 120, end panels 130, and may be used to hold light source 410. Tether 620 may be a cord, or fixture that anchors stand support 610 to side panel 120.

FIG. 7 illustrates a depiction of a side view of a tile 110. This depiction is a bottom panel 140 incorporating a tile 110 thereon. The tile may be arranged in a pattern 510.

Tile 110 may be of any suitable shape. Tile 110 may be square or rectangular. Tile 110 may be any suitable material. Tile 110 may be a water resistant material. Tile 110 may be foam board. Tile 110 may be plastic. Tile 110 may be positioned underneath a container 150.

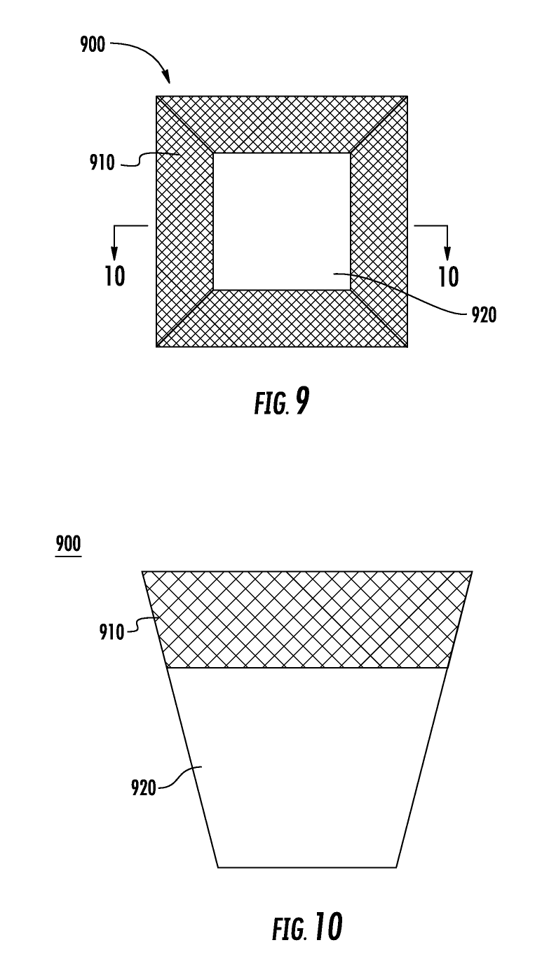

FIG. 8 illustrates a top view of a bottom panel 140. Bottom panel 140 may include pattern 510 thereon. Bottom panel 140 may include connectors 810 (shown as connectors 810a-d) and may include connectors 820 (shown as connectors 820a-d).

Pattern 510 may be of any suitable shape pattern. Pattern 510 may be designed to reflect or disperse light inward (i.e., toward a plant) and/or upward to increase the amount of light a plant above tile 110 receives. Pattern 510 may be raised, flat, indented, or any combination thereof. Pattern 510 may be a diamond-shaped pattern. Pattern 510 may be made of or coated with any reflective material. Pattern 510 may be made of a mylar or mylar-like reflective material. The reflective material may form pattern 510, or may be positioned on a substrate having the terrain for pattern 510. Pattern 510 may be a raised pattern. Pattern 510 may be a raised pattern that scatters light.

Each of connectors 810, 820 may be any suitable shape. An interlocking part may be a trapezoid. Connectors 810, 820 may be positioned such that each pairs with a space between interlocking parts from another tile 110 in order to secure the two together. Tile 110 may contain one or more interlocking parts.

Connectors 810 (a-d) may be designed to allow to connect to connectors 820 (a-d) in an interlocking manner to enable tiles 110 to be joined together to form a bottom panel 140, for example. While the present description focuses on trapezoidal connectors 810, 820, any suitable shape of design may be used to hold tiles 110 together to form bottom panel 140. Tiles 110 may be joined simply by pushing the end of one tile 110 adjacent to another tile 110, for example.

FIG. 9 illustrates a depiction of a container 900 that may be utilized in any of the systems described herein. Container 900 includes a reflector 910 and contents 920.

Container 900 may be a plant pot. Container 900 may be a container in which flowers and other plants may be cultivated and displayed. Container 900 may be, but is not limited to being, made from terracotta, plastic, wood, stone, and/or biodegradable material. Container 900 may include holes in the bottom, to allow excess water to flow out. Container 900 may be coupled to or interconnected with a saucer (not shown) under container 900. The plant or other organic housed within container 900 may use the water captured in the saucer with its roots, as needed. Container 900 may be operably or directly connected to an automatic watering system, such as a reservoir. Container 900 may provide the ability to transport plants to new locations, starting seeds, patio and indoor cultivation of plants, and the growing of tender plants in colder regions indoors. The top of container 900 may provide a shoulder or collar underneath the rim to aid in handling container 900.

Reflector 910 may be any coating or material that increases the reflectivity of a surface. Reflector may include light dispersion techniques that provide light in discrete units, as would be beneficial for quantized placement of the containers with plants.

Contents 920 may include any material contained within container 900 associated with the plant or organic material. Contents 920 may include dirt, soil, nutrients, the plant and its roots, fertilizer spikes, and other products necessary for the development of plants. Contents 920 may be mixed together or may be layered as needed. Container 900 may be empty. When empty, it could still be utilized to redirect light within the system for plants or other organics in other containers.

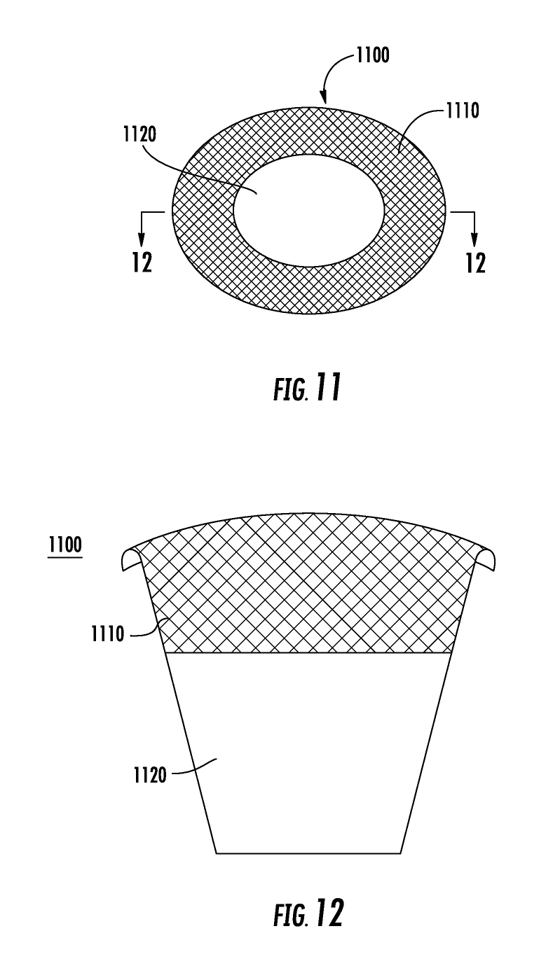

FIG. 10 illustrates an internal cross-section of container 900 cut along line 10-10. This cross-section illustrates container 900 with reflector 910 and contents 920. Reflector 910 may be formed near the top of container 900 and may extend down to the contents 920, or beyond. A reflector may be similarly positioned on the exterior of container 900. Exterior reflectors may increase light directed to other containers, or through multiple reflections within the system, back onto a plant in container 900.

Container 900 may be made of any suitable material, including but not limited to plastic. Container 900 may be any size. Container 900 is illustrated as a square when viewed from the top, but as illustrated in FIGS. 9, 11, 13, and 15, a container may have any geometrical shape. Container 900 may be any four-sided pot. Container 900 may be a two inch by two inch cube. Container 900 may be a four inch by four inch cube. Reflector 910 may extend for a portion of or surround the upper inner portion of Container 900. Reflector 910 may include any suitable material. Reflector 910 may be any material that reflects light. Reflector 910 and/or exterior reflectors may be a removable reflective strip. Removable reflective strip may be secured to the interior surface of container 900 by any suitable fixative. The fixative may be tension provided by the removable reflective strip around the interior. The fixative may be an adhesive.

FIG. 11 illustrates a depiction of a container 1100 that may be utilized in any of the systems described herein. Container 1100 includes a reflector 1110 and contents 1120. Container 1100 may be made of any suitable material, including but not limited to plastic. Container 1100 may be any size. Container 1100 is illustrated with a frusto-conical shape, but reference to FIGS. 9, 11, 13, and 15 shows that a reflective plant growth container may have any geometrical shape. Container 1100 may be any pot. Reflector 1110 may extend for a portion of or surround the upper inner portion of container 1100. The container 1110 may include an exterior reflector.

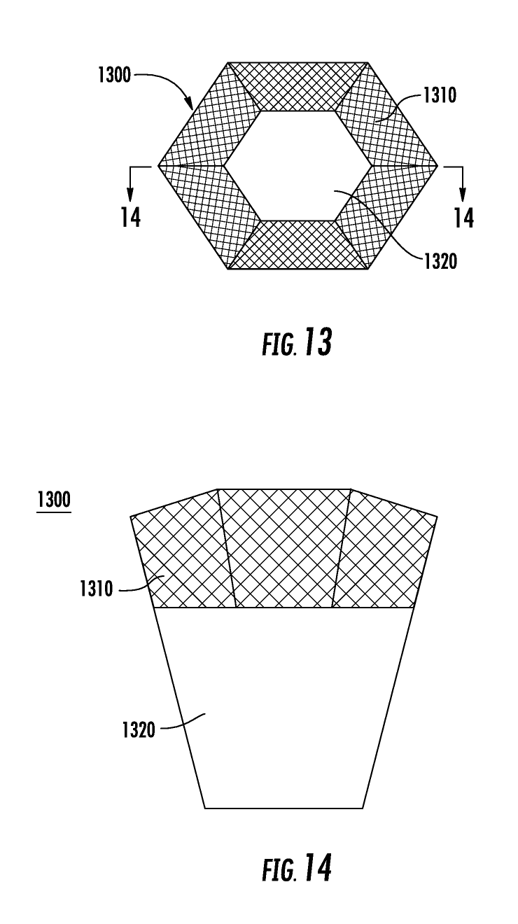

FIG. 12 illustrates an internal cross-section of container 1100 cut along line 12-12. This cross-section illustrates container 1100 with reflector 1110 and contents 1120. Reflector 1110 may be formed near the top of container 1100 and may extend down to the contents 1120, or beyond.

FIG. 13 illustrates a depiction of a container 1300 that may be utilized in any of the system described herein. Container 1300 includes a reflector 1310 and contents 1320. Container 1300 may be made of any suitable material, including but not limited to plastic. Container 1300 may be any size. Container 1300 is illustrated as hexagonal as viewed from the top, but as illustrated in FIGS. 9, 11, 13, and 15, a reflective plant growth container may have any geometrical shape. Container 1300 may be any multi-sided pot. Reflector 1310 may extend for a portion of or surround the upper inner portion of container 1300. Container 1300 may have an exterior reflector.

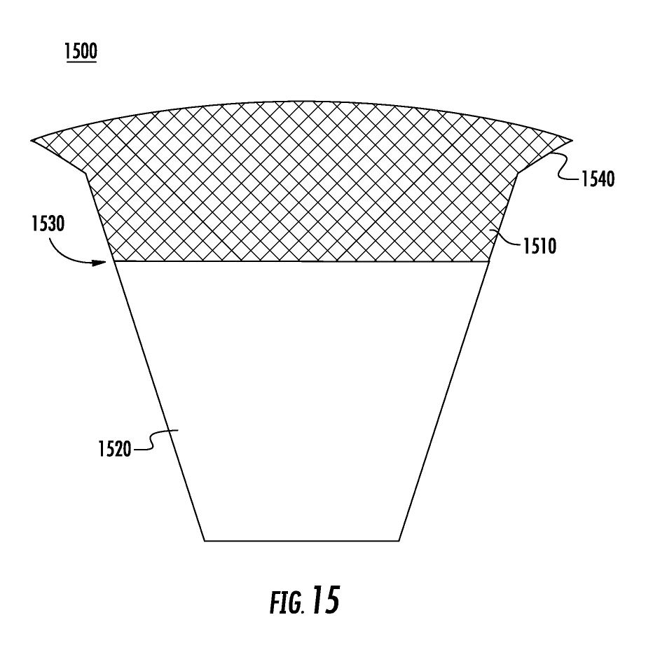

FIG. 14 illustrates an internal cross-section of container 1300 cut along line 14-14. This cross-section illustrates container 1300 with reflector 1310 and contents 1320. Reflector 1310 may be formed near the top of container 1300 and may extend down to the contents 1320, or beyond.

FIG. 15 illustrates an internal cross-section of a container 1500. Container 1500 includes a reflector 1510 and contents 1520, as described with respect to the containers of other figures. Container 1500 includes a fill line 1530 and a lip 1540. Container 1500 may be any pot with a lip 1540. Reflector 1510 may extend for a portion of or surround the upper inner portion of container 1500. Reflector 1510 may extend from fill line 1530 to the top of container 1500, and may extend onto the lip 1540. Container 1500 may have an exterior reflector.

Fill line 1530 may include a denotation on container 1500 to identify the top level that the contents 1520 may be filled within container 1500. This may include any contents 1520 that are included within container 1500 or may be based on the type of contents 1520. That is, solid contents 1520 may have one fill line 1530 that may be different from the fill line 1530 for liquid contents 1520.

Lip 1540 may take the form of a flange that is an external or internal ridge, or rim (lip), for strength, and to provide additional light reflection.

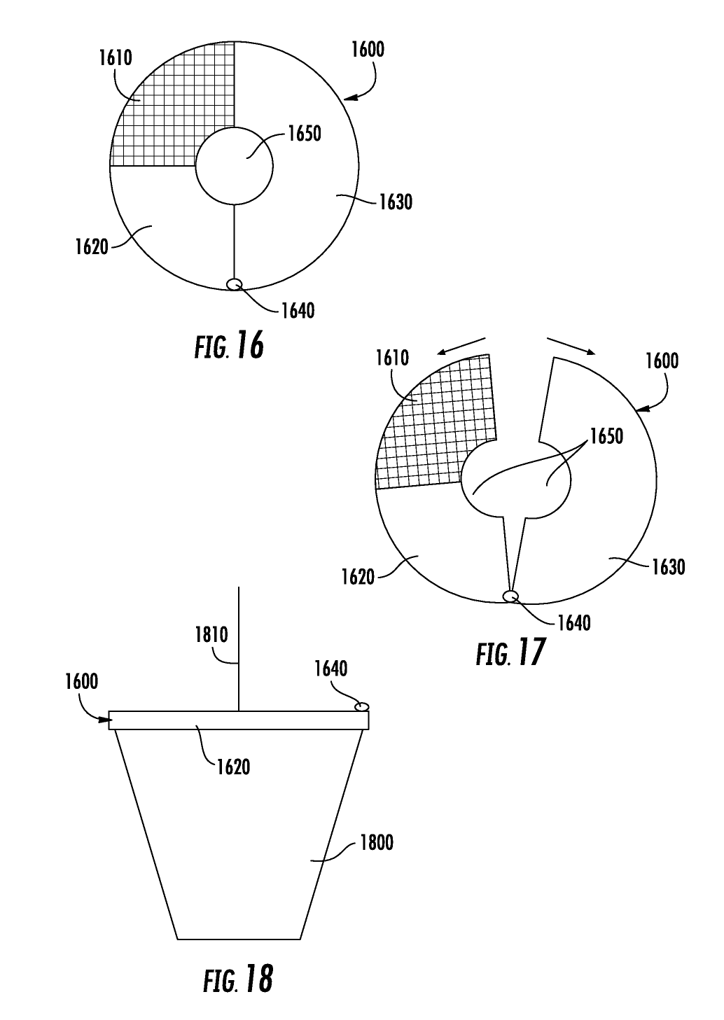

FIG. 16 illustrates a depiction of a cover 1600 which may cover a container in the system including any one of the containers described herein. Although illustrated as circular, the cover may have other shapes, and may or may not match the shape of the container it is covering. Cover 1600 includes a reflector 1610 in a similar fashion to the reflectors used on container described herein. Cover 1600 may include a first portion 1620 and a second portion 1630. First portion 1620 and second portion 1630 may be interconnected by an attachment 1640. Cover 1600 may include an opening 1650. Opening 1650 may be in the center of cover 1600, for example. Portion of opening 1650 may be included in first portion 1620 and the other portion may be included in second portion 1630.

Cover 1600 may be plastic. Reflector 1610 may be formed from any material that reflects light. Reflector 1610 may have any suitable pattern. Reflector 1610 may have a diamond pattern. Reflector 1610 may be raised, flat, indented, or any combination thereof. Reflector 1610 may cover all or a part of cover 1600. For example, reflector 1610 may cover the entire top surface of cover 1600. Cover 1600 may include two portions, a first portion 1620 and a second portion 1630. First portion 1620 may be attached to second portion 1630 by attachment 1640. Attachment 1640 may be any suitable means of attachment including single and multiple attachments. Attachment 1640 may function as a hinge. Attachment 1640 may be a rivet.

Opening 1650 may be of any suitable size. Opening 1650 may be of any suitable shape. Opening 1650 may be large enough for a plant to extend through to the interior of container of FIGS. 9, 11, 13, and 15, for example. Opening 1650 may have a 3 inch diameter.

Cover 1600 may be coupled to any of the containers described herein. Cover 1600 may be formed from the same material as the container, or may be any suitable material for promoting plant growth. Cover 1600 may include curvature, slope or a depression near the opening to aid in the capture and delivery of water to the contained plant. The cover may include curvature to allow water incident on the cover to flow into the container via the opening. That is, cover may be bowl-shaped allowing water captured in the cover 1600 to eventually enter container 1600 through opening 1650.

FIG. 17 illustrates a depiction of cover 1600 partially opened. First and second portions 1620, 1630 may be actuated at a single attachment 1640 to spread apart as shown. Cover 1600 may open by separating first portion 1620 from second portion 1630.

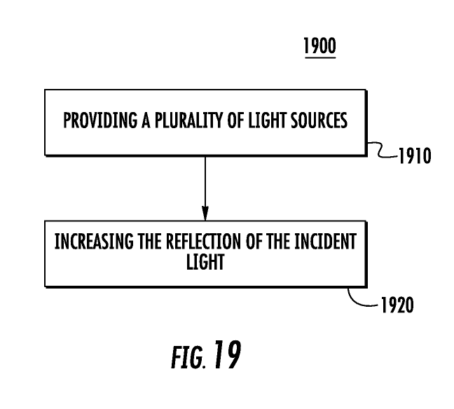

FIG. 18 illustrates a container 1800 including cover 1600. As is shown in FIG. 18, cover 1600 includes a first portion 1620 and a second portion (not shown), coupled via an attachment 1640. Container 1800 includes a plant 1810 growing through the opening 1650 (not shown) in cover 1600. Cover 1600 may be placed on top of container 1800. Container 1800 may be any container described herein. Cover 1600 may be attached to container 1800 by attachment 1640, or another attachment, or may be placed on top of container 1800. Attachment 1640 may be any suitable means of attachment. Attachment 1640 may be a rivet. Cover 1800 may be situated such that opening 1650 surrounds plant 1810 as the plant extends from container 1800.

Plant 1810 may be but is not limited to any of the various photosynthetic, eukaryotic, multicellular organisms of the kingdom Plantae characteristically producing embryos, containing chloroplasts, having cellulose cell walls, and lacking the power of locomotion. Plant 1810 may be a microorganism.

FIG. 19 illustrates a method 1900 for assembling a system to provide additional light to at least one plant. Method 1900 includes receiving light from at least one light source at step 1910. Method 1900 includes increasing the reflection of the incident light on at least one of at least one bottom panel, one or more side panels, one or more end panels, and at least one container at step 1920. The at least one bottom panel, one or more side panels, one or more end panels form a housing for the at least one container, the container configured to house the at least one plant.

The method 1900 may include increasing the reflection of the incident light on at least one cover for the at least one container. In the method 1900, increasing the reflection may include a pattern to increase the reflectivity.

Embodiments herein include any container having a pot and a reflective surface. As used herein, “pot” and “container” means any vessel used to hold a plant. The reflective surface may include a separate reflective surface that is later affixed to the pot. The reflective surface may include a reflective strip with adhesive backing. A reflective surface may have reflective features as described for pattern 510.

A container and/or system may be positioned in a manner that allows a plant to receive the maximum amount of light available. The desired reflectivity may be the maximum amount of light available.

Any container(s), pot(s), reflective strip(s), reflective cover(s), tile(s), or side panel(s) herein could be manufactured separately or in any combination. Any container(s), pot(s), reflective strip(s), reflective cover(s), tile(s) or side panel(s) herein could be packaged separately or in any combination as a system herein.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A system for providing increased light to at least one plant, the system comprising:
at least one bottom panel including at least one tile;
one or more side panels operatively coupled to the at least one bottom panel and providing a first reflector to redirect light within the system; and
at least one container configured to house the at least one plant, be supported by the at least one bottom panel, and providing a second reflector to redirect light within the system.

2. The system of claim 1 wherein the operative coupling of one or more side panels is substantially perpendicular to the at least one bottom panel at an edge of the bottom panel and providing a first reflector to redirect light within the system.

3. The system of claim 1 further comprising one or more end panels operatively coupled to the at least one bottom panel and the one or more side panels and providing a third reflector to redirect light within the system.

4. The system of claim 1 wherein the operative coupling of one or more one or more end panels is substantially perpendicular to the at least one bottom panel at a second edge of the bottom panel and substantially orthogonally to some of the one or more side panels.

5. The system of claim 1 further comprising at least one light source producing light beneficial to at least one plant, the light incident upon the bottom panel, the one or more side panels, and the at least one container, the bottom panel, one or more side panels, and the at least one container each reflecting a portion of the incident light.

6. The system of claim 1 further comprising at least one cover for the at least one container, the cover including a first portion and a second portion coupled via an attachment, the cover providing an opening to allow the plant to grow through.

7. The system of claim 6 wherein the cover also includes curvature to allow water incident on the cover to flow into the container via the opening.

8. The system of claim 6 wherein the at least one cover includes a pattern to increase the reflectivity of the cover to redirect light in the system.

9. The system of claim 6 wherein the at least one cover includes a reflector to increase the reflectivity of the cover to incident light.

10. The system of claim 1 wherein the plurality of tiles increase reflection of the bottom panel.

11. The system of claim 1 wherein the plurality of tiles increase reflection of bottom panel by including a reflective surface, a reflective coating, or a combination of reflective surface and reflective coating.

12. The system of claim 1 wherein the one or more side panels include a pattern to increase the reflectivity of the panels to provide additional light incident on the plant housed in the container.

13. The system of claim 1 wherein the one or more side panels include a reflector to increase the reflectivity of the panels to incident light.

14. The system of claim 1 wherein the at least one container includes a pattern to increase the reflectivity of the panels to provide additional light incident on the plant housed in the container.

15. The system of claim 1 wherein the at least one container includes a reflector to increase the reflectivity of the container to incident light.

16. The system of claim 1 wherein the plurality of tiles are interconnected using a plurality of connectors.

17. An apparatus for housing a plant and providing increased light incident on the plant, the apparatus comprising
at least one container configured to house at least one of a plurality of plants and a reflector to reflect light incident on the container.

18. The apparatus of claim 17 further comprising at least one cover for the at least one container, the cover including a first portion and a second portion coupled via an attachment, the cover providing an opening to allow the plant to grow through.

19. The apparatus of claim 18 wherein the cover also includes curvature to allow water incident on the cover to flow into the container via the opening.

20. The apparatus of claim 18 wherein the at least one cover includes a pattern to increase the reflectivity of the cover to reflect light incident on the cover.

21. The apparatus of claim 18 wherein the at least one cover includes a reflector to increase the reflectivity of the cover to incident light.

22. The apparatus of claim 17 wherein the at least one container includes a pattern to increase the reflectivity of the panels to reflect light incident on the cover.

23. The apparatus of claim 17 wherein the at least one container includes a reflector to reflect light incident on the container.

24. A method of providing increased light to at least one plant, the method comprising:
increasing the reflection of the incident light on at least one of at least one bottom panel, one or more side panels, one or more end panels, and at least one container; the at least one bottom panel, the one or more side panels, and the one or more end panels forming a housing for the at least one container, the container configured to house the at least plant.

25. The method of claim 24 further comprising increasing the reflection of the incident light on at least one cover for the at least one container.

26. The method of claim 24 wherein increasing the reflection includes a including a pattern on one or more of the at least one of at least one bottom panel, one or more side panels, one or more end panels, and at least one container to increase the reflection of the incident light.

27. The method of claim 24 wherein increasing the reflection includes a including a reflector on one or more of the at least one of at least one bottom panel, one or more side panels, one or more end panels, and at least one container.

28. The method of claim 24 further comprising providing light from at least one light source configured to produce light beneficial to the at least one plant.

29. The method of claim 24 wherein the increased light does not require additional energy to the light sources.
